(19) United States
(12) Patent Application Publication
(10) Pub. No.: US 2005/0139242 A1
(43) Pub. Date: Jun. 30, 2005

(54) Method for removing color photoresist

(75) Inventor: Sang Woo Nam, Cheongju-si (KR)

Correspondence Address: THE LAW OFFICES OF ANDREW D. FORTNEY, PH.D., P.C., 7257 N. MAPLE AVENUE, BLDG. D, 3107, FRESNO, CA, 93720, US

(73) Assignee: DongbuAnam Semiconductor Inc.

(21) Appl. No.: 11/027,434

(22) Filed: Dec. 30, 2004

(30) Foreign Application Priority Data
Dec. 31, 2003 (KR) 10-2003-0102065

(51) Int. Cl. B08B 3/00

(52) U.S. Cl. 134/103.1

(57) ABSTRACT

A method for completely removing color photoresist is disclosed. A disclosed method comprises: performing a first plasma ashing process to remove color photoresist on a substrate having at least one predetermined structure; performing a wet etch; and performing a second plasma ashing process to remove the residues of the color photoresist.

### BACKGROUND OF THE INVENTION

1. Field of the Invention

The present invention relates to a method for removing color photoresist and, more particularly, to a method for completely removing color photoresist by performing a first plasma etch, a wet cleaning and a second plasma etch, sequentially.

2. Background of the Related Art

Conventionally, a color image sensor fabrication method comprises steps as follow. First, predetermined devices such as MOS capacitors are formed in accordance with a CMOS or a CCD technology. After, an insulating layer is formed to protect the devices. Color filter arrays are then formed on the predetermined parts of the insulating layer. In this step, photolithography processes have to be performed three times to make the three primary colors such as blue, red and green correspond to each pixel.

FIGS. 1a through 1c are top and cross-sectional views illustrating a process for forming the color filter in accordance with the conventional method.

Referring to FIG. 1a, a red color filter material R is coated on a substrate 11. Subsequently, the red color filter material R is patterned by a selective exposure process and a development process.

Referring to FIG. 1b, a blue color filter material B is coated on the patterned red color filter material R of the resulting structure. Subsequently, a selective exposure process and a development process are again performed to pattern the blue color filter material B.

Referring to FIG. 1c, a green color filter material G is coated on the resulting structure having the patterned red color filter material R and blue color filter material B. Subsequently, a selective exposure process and a development process are performed to pattern the green color filter material G. In general, the ratio of a red color filter R, a blue color filter B and a green color filter G in an array is 1:1:2.

However, in the above-described conventional method, a common plasma ashing process cannot completely remove color photoresist with defects because the dyes of the color photoresist still remain on the surface of the wafer. Thus, the wafer is scrapped due to the residue of the color photoresist, and a manufacturing cost greatly increases.

### SUMMARY OF THE INVENTION

An object of the present invention is to provide a method for completely removing color photoresist by performing a first plasma etch, a wet cleaning and a second plasma etch, sequentially, thereby recycling a wafer.

To achieve this object, in accordance with the purpose of the invention, as embodied and broadly described herein, a method for fabricating a gate electrode according to the present invention comprises: performing a first plasma ashing process to remove color photoresist on a substrate having at least one predetermined structure; performing a wet etch; and performing a second plasma ashing process to remove the residues of the color photoresist.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1a through 1c are top and cross-sectional views illustrating a process for forming the color filter in accordance with the conventional method; and

FIGS. 2a through 2d are cross-sectional views illustrating a process for removing color photoresist in accordance with the present invention.

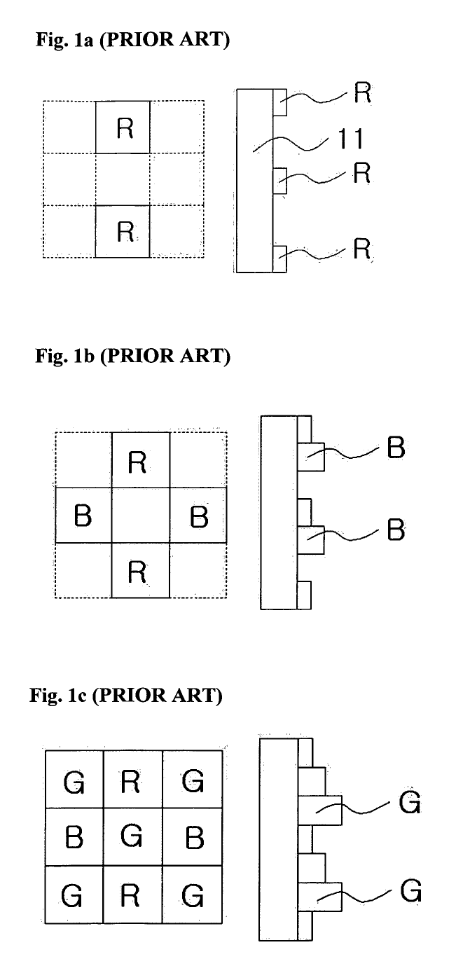

### DETAILED DESCRIPTION OF THE PREFERRED EMBODIMENT

Reference will now be made in detail to the preferred embodiments of the present invention, examples of which are illustrated in the accompanying drawings.

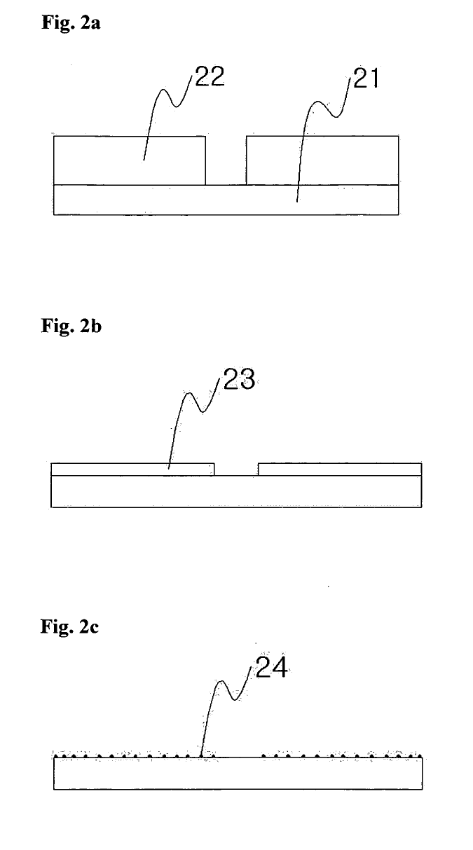

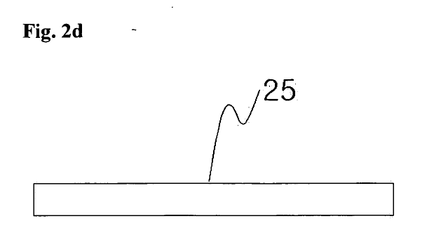

FIGS. 2a through 2d are cross-sectional views illustrating a process for removing color photoresist in accordance with the present invention.

Referring to FIG. 2a, a first plasma ashing process is performed to remove color photoresist 22 on a substrate 21 with at least one predetermined structure. The color photoresist comprises photosensitive polymers and dyes such as red, blue and green color. The first plasma ashing process is performed under an O₂ atmosphere between 200 sccm and 500 sccm and under a N₂ atmosphere between 50 sccm and 500 sccm. In addition, the first plasma ashing process is performed with a pressure between 0.5 Torr and 5 Torr, with a power between 100 W and 1500 W, at a temperature between 150° C. and 300° C., and for a time between 50 seconds and 200 seconds.

Referring to FIG. 2b, a wet etch is performed to remove the residue of the color photoresist which are made of dyes depositing on the substrate even after the first plasma ashing process has been performed. The wet etch is performed with HDA (HyDroxyl Amine) for a time between 2 minutes and 10 minutes.

Referring to FIG. 2c, a second plasma ashing is performed to completely remove the residue of the color photoresist 24 remaining even after the wet etch. The second plasma ashing is performed under an O₂ atmosphere between 200 sccm and 5000 sccm and under a N₂ atmosphere between 50 sccm and 500 sccm. Additionally, the second plasma ahsing process is performed with a pressure between 0.5 Torr and 5 Torr, with a power between 100 W and 1500 W, at a temperature between 150° C. and 300° C., and for a time between 50 seconds and 200 seconds.

FIG. 2d illustrates the surface 25 of the substrate which has no residue of the color photoreist after the second plasma ashing process.

Accordingly, the present invention provides the method for completely removing the color photoresist by performing the first plasma etch, the wet cleaning and the second plasma etch, sequentially, thereby recycling a wafer.

It is noted that this patent claims priority from Korean Patent Application Serial Number 10-2003-0102065, which was filed on Dec. 31, 2003, and is hereby incorporated by reference in its entirety.

Although certain example methods, apparatus and articles of manufacturing have been described herein, the scope of coverage of this patent is not limited thereto. On the contrary, this patent covers all methods, apparatus and articles of manufacture fairly falling within the scope of the appended claims either literally or under the doctrine of equivalents.

1. A method for removing color photoresist comprising the steps of:
performing a first plasma ashing process to remove color photoresist on a substrate having at least one predetermined structure;
performing a wet etch; and
performing a second plasma ashing process to remove the residue of the color photoresist.

2. A method as defined by claim 1, the first and the second plasma ashing processes are performed under an O₂ atmosphere between 200 sccm and 5000 sccm and under a N₂ atmosphere between 50 sccm and 500 sccm.

3. A method as defined by claim 1, the first and the second plasma ashing processes are performed with a pressure between 0.5 Torr and 5 Torr.

4. A method as defined by claim 1, the first and the second plasma ashing processes are performed with a power between 100 W and 1500 W.

5. A method as defined by claim 1, the first and the second plasma ashing processes are performed at a temperature between 150° C. and 300° C.

6. A method as defined by claim 1, the first and the second plasma ashing processes are performed for a time between 50 seconds and 200 seconds.

7. A method as defined by claim 1, the wet etch is performed with HDA for a time between 2 minutes and 10 minutes.

8. A method as defined by claim 1, the color photoresist comprises photosensitive polymers and dyes such as red, blue and green color.
